(19) United States
(12) Patent Application Publication
(10) Pub. No.: US 2015/0312319 A1
(43) Pub. Date: Oct. 29, 2015

(54) ACCESS POINT WITH LIMITED RANGE

(71) Applicant: QUALCOMM Incorporated, San Diego, CA (US)

(72) Inventor: Maarten Menzo Wentink, Naarden (NL)

(21) Appl. No.: 14/688,182

(22) Filed: Apr. 16, 2015

Related U.S. Application Data
(60) Provisional application No. 61/985,974, filed on Apr. 29, 2014.
(60) Provisional application No. 62/010,933, filed on Jun. 11, 2014.

(51) Int. Cl. H04L 29/08; H04W 72/04

(52) U.S. Cl. CPC H04L 67/04; H04W 72/0413

(57) ABSTRACT

Methods, systems, and devices are described for limiting the range of an access point. An access point (AP) may transmit a beacon advertising supported for a set of low bit rates to achieve backwards compatibility for devices that expect support for those rates. If a station (STA) sends a data packet using one of the low bit rates, the AP may refrain from transmitting an acknowledgement (ACK) of the transmission to the STA. The AP may also transmit a disassociation or deauthentication frame. This may cause devices outside of a limited range to disassociate from the AP. In some examples, the AP may indicate that it will not communicate using the set of low bit rates. The AP may transmit beacons or probe responses at higher bit rates.

### CROSS REFERENCES

The present application for patent claims priority to U.S. Provisional Patent Application No. 61/985,974 by Wentink, entitled “Access Point with Limited Range,” filed Apr. 29, 2014, and U.S. Provisional Patent Application No. 62/010,933 by Wentink, entitled “Access Point with Limited Range,” filed Jun. 11, 2014, assigned to the assignee hereof, and expressly incorporated by reference herein.

### BACKGROUND

1. Field of Disclosure

The following relates generally to wireless communication, and more specifically to limiting the range of an access point.

2. Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power).

A wireless communications network may include a number of network devices such as access points (APs) that can support communication for a number of wireless devices. A wireless device may communicate with a network device bi-directionally. For example, in a wireless local area network (WLAN), a station (STA) may communicate with an associated AP via downlink and uplink. The downlink (or forward link) refers to the communication link from the AP to the station, and the uplink (or reverse link) refers to the communication link from the station to the AP. In some cases, it may be appropriate for an AP to limit its coverage range. For example, the AP may be able to provide better service for STAs within a limited range by restricting communications with devices beyond the limited range. Because lower bit rate transmissions may be associated with robust modulation and coding schemes with an extended range, an AP may limit its range by advertising support for only higher bit rates. However, if the AP limits its range by restricting communications at low bit rates, the AP may lose connectivity with devices that are capable of communicating at higher bit rates, but expect support for lower bit rates.

### SUMMARY

The described features generally relate to one or more improved systems, methods, and/or apparatuses for limiting the range of an AP and thereby reducing the use of low bitrates and according long lasting transmissions. The long lasting transmissions may cause congestion in the network. An AP may transmit a beacon advertising supported for a set of low bit rates to achieve backwards compatibility for devices that expect support for those rates. If a STA sends a data packet using one of the low bit rates, the AP may refrain from transmitting an acknowledgement (ACK) of the transmission to the STA. The AP may additionally or alternatively transmit a disassociation or deauthentication frame in response to the low bit rate data packet from the STA. The disassociation or deauthentication frame may cause devices outside of a limited range to disassociate from the AP. In some examples, the AP may also indicate to newer STAs that the AP will not communicate data packets using the set of low bit rates even though the set of low bit rates is indicated as supported for legacy compatibility purposes. The AP may transmit beacons and/or probe responses at higher bit rates.

A method of wireless communication is described, the method may include advertising, by an access point (AP), a plurality of supported bit rates, wherein the plurality of supported bit rates comprises a first subset of bit rates and a second subset of bit rates, receiving a transmission from a wireless station at a first bit rate, and adapting communication with the wireless station to limit a range of the AP, wherein the adaptation is based at least in part on a determination that the first bit rate is in the first subset.

An apparatus for wireless communication is described, the apparatus may include means for advertising, by an access point (AP), a plurality of supported bit rates, wherein the plurality of supported bit rates comprises a first subset of bit rates and a second subset of bit rates, means for receiving a transmission from a wireless station at a first bit rate, and means for adapting communication with the wireless station to limit a range of the AP, wherein the adaptation is based at least in part on a determination that the first bit rate is in the first subset.

An apparatus for wireless communication is also described, the apparatus may include a processor, a bit rate advertiser to advertise a plurality of supported bit rates, wherein the plurality of supported bit rates comprises a first subset of bit rates and a second subset of bit rates, a receiver to receive a transmission from a wireless station at a first bit rate, and a communication adapter to adapt communication with the wireless station to limit a range of an access point (AP), wherein the adaptation is based at least in part on a determination that the first bit rate is in the first subset.

A non-transitory computer-readable medium storing code for wireless communication is described. The code may include instructions executable to advertise, by an access point (AP), a plurality of supported bit rates, wherein the plurality of supported bit rates comprises a first subset of bit rates and a second subset of bit rates, receive a transmission from a wireless station at a first bit rate, and adapt communication with the wireless station to limit a range of the AP, wherein the adaptation is based at least in part on a determination that the first bit rate is in the first subset.

In some examples of the method, apparatuses, and/or non-transitory computer-readable medium described above adapting communication with the wireless station includes refraining from transmitting an acknowledgement of the transmission to the wireless station. In some cases, the first subset of bit rates is associated with a longer transmission range than the second subset of bit rates. In some examples, adapting communication with the wireless station includes transmitting a frame to the wireless station, wherein the frame is from the group consisting of a disassociation frame or a deauthentication frame.

In some examples of the method, apparatuses, and/or non-transitory computer-readable medium described above, the frame is transmitted to the wireless station after an SIFS following the transmission from the wireless station. In some examples, the frame is transmitted to the wireless station at the first bit rate.

In some examples of the method, apparatuses, and/or non-transitory computer-readable medium described above, advertising the plurality of supported bit rates includes designating the bit rates of the first subset as basic rates. In some examples, advertising the plurality of bit rates comprises transmitting an indication that the AP is refraining from using the bit rates of the first subset to communicate data packets.

In some examples of the method, apparatuses, and/or non-transitory computer-readable medium described above, a beacon or a probe response may be transmitted at a second bit rate of the second subset. In some examples, the access point may refrain from using the bit rates of the first subset to communicate data packets.

Some examples of the method, apparatuses, and/or non-transitory computer-readable medium described above may further comprise transmitting a message at a second bit rate of the second subset, wherein the message is selected from the group consisting of a beacon and a probe response. Some examples of the method, apparatuses, and/or non-transitory computer-readable medium described above may further comprise transmitting beacon and group traffic at a second bit rate from the second subset of bit rates prior to receiving the transmission from the wireless station at the first bit rate.

In some examples of the method, apparatuses, and/or non-transitory computer-readable medium described above, adapting communication with the wireless station comprises transmitting the beacon and group traffic at a bit rate selected from the first subset of bit rates in response to receiving the transmission from the wireless station at the first bit rate. Some examples of the method, apparatuses, and/or non-transitory computer-readable medium described above may further comprise refraining from enabling legacy protection in response to receiving the transmission from the wireless station at the first bit rate. In these examples, refraining from enabling legacy protection may comprise continuing to implement a short slot transmission opportunity (TXOP) after receiving the transmission from the wireless station at the first bit rate.

Some examples of the method, apparatuses, and/or non-transitory computer-readable medium described above may further comprise refraining from transmitting beacons in response to a determination that no wireless stations are currently associated with the AP. Some examples of the method, apparatuses, and/or non-transitory computer-readable medium described above may further comprise identifying one of the supported bit rates as a data rate that can be received by all wireless stations currently associated with the AP, and transmitting a beacon at the identified one of the supported bit rates.

In some examples of the method, apparatuses, and/or non-transitory computer-readable medium described above, the one of the supported bit rates is identified based at least in part on a received signal strength indication (RSSI) for each of the wireless stations currently associated with the AP. Some examples of the method, apparatuses, and/or non-transitory computer-readable medium described above may further comprise transmitting group traffic at the identified one of the supported bit rates.

Further scope of the applicability of the described methods and apparatuses will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a wireless communications system in accordance with various embodiments;

FIG. 2 illustrates an example of a wireless communication subsystem for limiting the range of an AP in accordance with various embodiments;

FIG. 3 illustrates an example of a range limiting procedure in accordance with various embodiments;

FIG. 4 shows a block diagram of a device for limiting the range of an AP in accordance with various embodiments;

FIG. 5 shows a block diagram of a device for limiting the range of an AP in accordance with various embodiments;

FIG. 6 shows a block diagram of a device for limiting the range of an AP in accordance with various embodiments;

FIG. 7 illustrates a block diagram of a system for limiting the range of an AP in accordance with various embodiments;

FIG. 8 shows a flowchart illustrating a method for limiting the range of an AP in accordance with various embodiments;

FIG. 9 shows a flowchart illustrating a method for limiting the range of an AP in accordance with various embodiments; and

FIG. 10 shows a flowchart illustrating a method for limiting the range of an AP in accordance with various embodiments.

### DETAILED DESCRIPTION

The described features generally relate to one or more improved systems, methods, and/or apparatuses for limiting the range of an access point (AP). An AP may transmit a beacon advertising supported for a set of low bit rates to achieve backwards compatibility for devices that expect support for those rates. If a station (STA) sends a data packet using one of the low bit rates, the AP may refrain from transmitting an acknowledgement (ACK) of the transmission to the STA. The AP may additionally or alternatively transmit a disassociation or deauthentication frame to the STA in response to the low bit rate data packet. This behavior may cause devices outside of a limited range to disassociate from the AP. In some examples, the AP may indicate to the STAs that the AP will not communicate data packets using the set of low bit rates, despite the advertisement of support for the low bit rates. Certain STAs may determine from this indication that the AP only advertises support for the low bit rates for backwards compatibility, and that data packets are to be transmitted and received at the higher bit rates. In addition, the AP may transmit beacons or probe responses at the higher bit rates.

In some cases, STAs that are capable of communicating at higher bit rates may experience problems connecting with an AP that does not advertise support for the lower bit rates. For example, certain STAs may interpret a lack of advertised support for lower bit rates as an error, causing the STA to refrain from associating with the AP. Thus, by advertising support for the low bit rates, an AP may facilitate communications with devices that expect these bit rates to be supported. However the AP may then limit communications at the low bit rates by refraining from sending an ACK for data packets transmitted over the low rates or sending a disassociation/deauthentication frame to a STA in response to a data packet from the STA at one of the low rates. These range limiting procedures may allow the AP to optimize use of available bandwidth and improve performance for other connected STAs.

The following description provides examples, and is not limiting of the scope, applicability, or configuration set forth in the claims. Changes may be made in the function and arrangement of elements discussed without departing from the scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

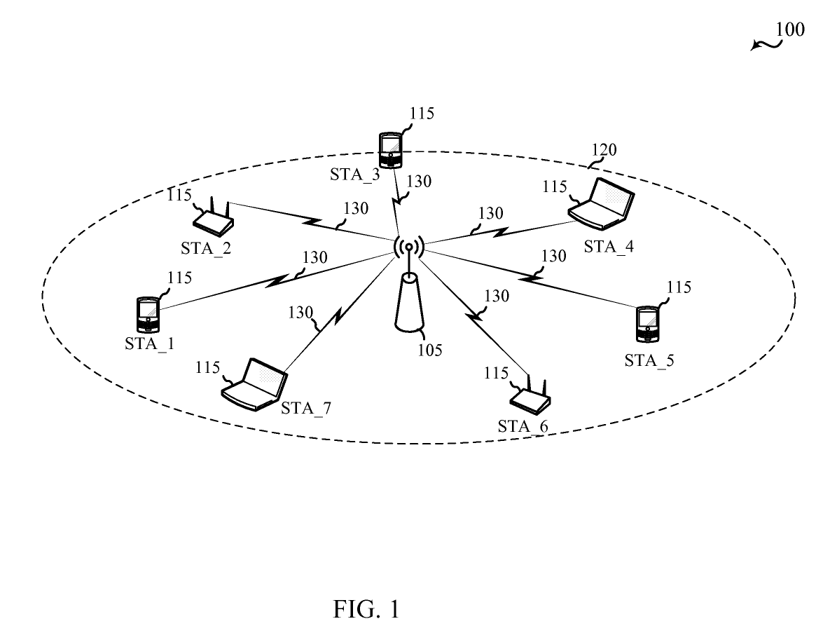

FIG. 1 illustrates a WLAN 100 (also known as a Wi-Fi network) configured in accordance with various embodiments. The WLAN 100 includes an access point (AP) 105 and multiple associated stations 115. In this example, there are shown seven (7) stations 115 (STAs), which are identified as STA_1, STA_2, STA_3, STA_4, STA_5, STA_6, and STA_7. The WLAN 100, however, may have more or fewer stations 115 than those shown in FIG. 1 since the number shown is simply for illustrative purposes. The AP 105 and the associated stations 115 may represent a basic service set (BSS) or an extended service set (ESS). The various stations 115 in the network are able to communicate with one another through the AP 105. Also shown is a coverage area 120 of the AP 105, which may represent a basic service area (BSA) of the WLAN 100. Although not shown in FIG. 1, an extended network base station associated with the WLAN 100 is typically connected to a wired or wireless distribution system (DS) that may allow multiple APs 105 to be connected in an ESS.

The AP 105 may be configured to communicate bi-directionally with each of the stations 115 using transmissions 130. The transmissions 130 may include downlink transmissions (e.g., beacon frames) that are sent from the AP 105 to a station 115 as well as uplink transmissions (e.g., acknowledgments or ACK frames) that are sent from a station 115 to the AP 105. Typically, the AP 105 is configured to broadcast its downlink transmissions to the stations 115 that are within the coverage area 120. In some cases, it may be appropriate for an AP 105 to limit communications to a smaller area within the coverage area 120. The AP 105 may therefore reduce its range by limiting communications at lower bit rates. Low bit rate communications may include increased use of redundancy or reliability techniques that increase the range of communications. However, low bit rates may also use more resources to communicate the same amount of data as higher bit rates.

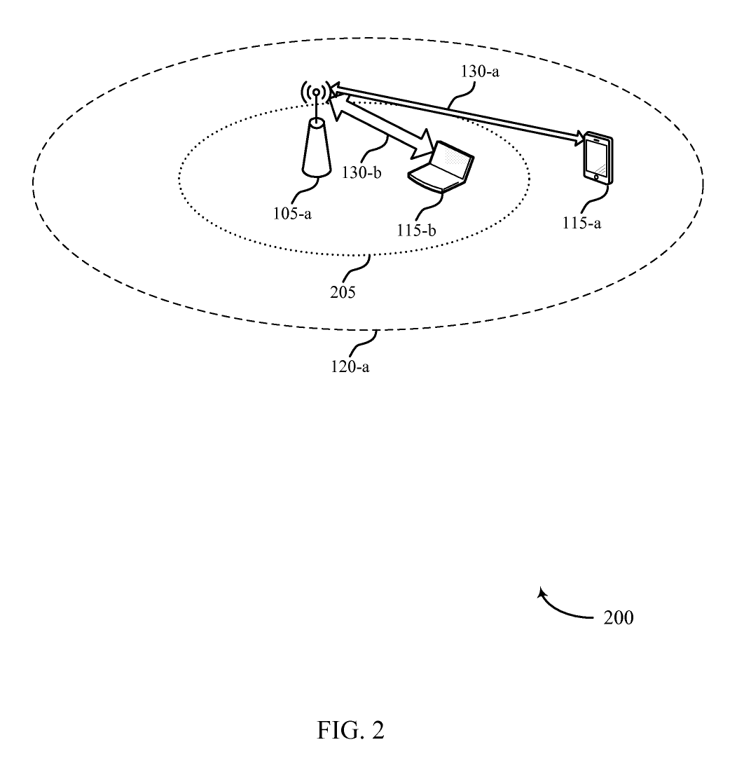

FIG. 2 illustrates an example of a wireless communications system 200 for limiting the range of an AP 105-a in accordance with various embodiments. The wireless communications system 200 of FIG. 2 may embody aspects of the WLAN 100 of FIG. 1. In the wireless communications system 200 of FIG. 2, an AP 105-a may be capable of communicating with STA 115-a at a relatively long range within coverage area 120-a using transmissions 130-a at a relatively low bit rate. For example, the AP 105-a may be capable of communicating at a rate specified by the Institute of Electrical and Electronics Engineers (IEEE) 802.11b standard such as 1 or 2 megabits per second (Mbps). AP 105-a may also be capable of communicating with STA 115-b at a shorter range within a limited range area 205 using transmissions 130-b at a higher rate (e.g., 5.5, 6, 11, 12, or 24 Mbps). It may be appropriate for the AP 105-a to restrict long range communications at the lower bit rates to optimize use of available resources. For example, the AP 105-a may be able to significantly improve communications with STA 115-b by reducing or eliminating slower communications at the lower bit rates with other STAs outside of the limited range area 205.

In some cases, a lack of advertised support for the low bit rates by the AP 105-a may cause compatibility problems with STA 115-a and/or STA 115-b. For example, a STA 115 may interpret the lack of advertised support as an indication that the AP 105-a is not compliant with one or more wireless standards or that the AP 105-a is not backwards compatible with earlier versions of a wireless standard. Such an interpretation may trigger an error at the STA 115, causing the STA 115 to not associate properly with the AP 105-a or not function properly once associated.

To address these issues, the AP 105-a may advertise support for communications at the low bit rates (e.g., the AP 105-a may indicate that these rates are basic rates), then engage in range limiting procedures to restrict or reduce transmissions at the low bit rates. The advertised support may be in the form of a periodic wireless beacon transmitted by the AP 105-a. In some cases, the AP 105-a may advertise support for the low bit rates for compatibility purposes. In other words, the rates may be advertised as basic rates but the AP 105-a may not communicate data at these rates. More generally, the AP 105-a may indicate a set of features that are supported for backward compatibility but which are not intended for use by a STA 115. In some cases, beacons and/or probe responses may be transmitted using a high bit rate, e.g., 6, 12, or 24 Mbps. In other cases, beacons and probes may be transmitted at a rate that is suitable for range limiting and that is also supported by older devices. For example, beacons and probes may be transmitted at one of the higher IEEE 802.11-b rates such as 5.5 or 11 Mbps.

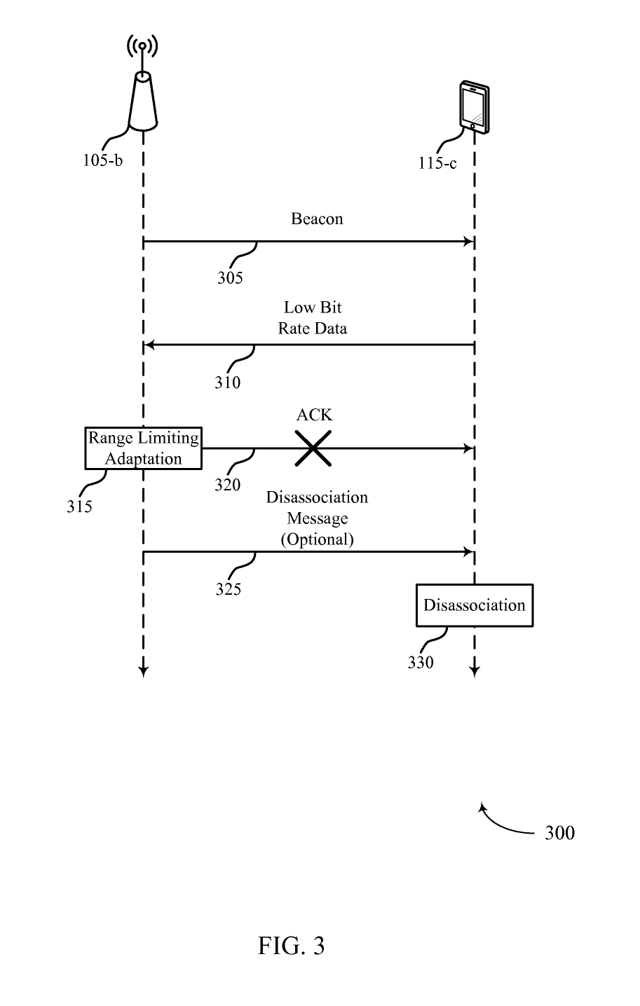

FIG. 3 illustrates an example of a range limiting procedure 300 in accordance with various embodiments. An AP 105-b may advertise a set of supported bit rates to a STA 115-c. For example, the AP 105-b may indicate that the rates are basic rates in a beacon transmission 305. The supported bit rates may include a first subset of bit rates and a second subset of bit rates. The first set of bit rates may be a set of relatively low bit rates (e.g., 1 Mbps and 2 Mbps). The second set of bit rates may be a set of higher bit rates (e.g., 5.5 Mbps and higher). In some examples advertising the supported bit rates may include designating the bit rates of the first subset as basic rates. In some examples, advertising the set of bit rates may include transmitting an indication that the AP is refraining from using the bit rates of the first subset to communicate data packets. For example, an information element (IE) containing the indication may be transmitted as part of a beacon signal. In some examples, a transmission other than a beacon signal may include the IE. Some STAs 115 may be capable of interpreting the indication to determine that the AP is advertising support for the low bit rates for the limited purpose of backward compatibility, while other STAs 115 may not be capable of interpreting the indication and may operate as if the AP 105-b fully supports the low bit rates. For example, STA 115-c may receive a beacon advertising support for the first set (of low bit rates) and transmit a message to AP 105-c using one of these bit rates.

The AP 105-b may then receive a transmission 310 from STA 115-c at a first bit rate. The first bit rate may be a low bit rate from the first set of bit rates. Based on the bit rate of the data transmission 310, the AP 105-b may select a range limiting adaptation 315 that may influence communication with STA 115-c. The selected range limiting adaptation may reduce the range of the AP 105-b and/or optimize the use of resources with other STAs 115. In some examples the first subset of bit rates is associated with a longer transmission range than the second subset of bit rates. In some examples adapting communication with the wireless station may include refraining from transmitting an acknowledgement (ACK) 320 for the transmission 310 to the STA 115-c. In some examples adapting communication with the wireless station includes transmitting a disassociation message 325 frame to STA 115-c. For example, the disassociation message 325 may include a deauthentication frame or a disassociation frame. The disassociation message 325 may be sent in conjunction with sending an ACK, or in addition to refraining from sending an ACK. In some examples, disassociation message 325 is transmitted to the wireless station after a short interframe space (SIFS) following the transmission 310 from STA 115-c. In some examples, the disassociation message 325 is transmitted to STA 115-c at the first bit rate. The AP 105-b may continue to transmit beacons and/or probe responses at a second bit rate of the second subset. The AP 105-b may then refrain from using the bit rates of the first subset to communicate data packets. Thus, AP 105-b may distinguish between data packets and other transmission frames such as discovery related frames and deauthentication/disassociation frames. AP 105-b may continue to transmit discovery and deauthentication/disassociation frames while refraining from transmitting data packets (or responding to data transmissions) using a low bit rate. This may result in some STAs 115 disassociating from AP 105-b, while other STAs 115 that are capable of communicating with the AP 105-b at a higher bit rate may continue to communicate with AP 105-b. This may also result in a reduced effective range that is smaller than the maximum coverage area 120 (as depicted in FIGS. 1-2).

As one example, AP 105-b may be backward compatible with STAs 115 supporting only IEEE 802.11b and earlier versions of the IEEE 802.11 standard (referred to herein as “802.11b-only STAs”). Thus, the advertised first set of bit rates may correspond to 802.11b rates (e.g., 5.5 or 11 Mbps) and the advertised second set of bit rates may correspond to a set of higher rates, (e.g., orthogonal frequency division multiplexing (OFDM) rates that are not supported by 802.11b). In this example, when no 802.11b-only STAs 115 are associated with the AP, beacon and group traffic may be sent at, e.g., 6 Mbps (or another OFDM rate). If an 802.11b-only STA 115 associates with AP 105-b, beacon and group traffic may be sent at an 11b rate. Probe responses may be transmitted at an 802.11b rate, e.g., 5.5 Mbps, irrespective of whether 802-11b-only STAs are associated with the AP, so that the AP can be discovered by 802.11b-only STAs at any time. Beacons, probe responses and association responses may indicate support for 802.11b rates (e.g., 5.5 Mbps or 11 Mbps), thus allowing for 802.11b-only devices to associate with the AP. Thus, 802.11b-only STAs 115 may discover and/or associate with AP 105-b.

In the 802.11b example described above, use of 802.11b rates by STAs 115 that support OFDM may be minimal. AP 105-b may mitigate the impact of 802.11b-only STAs 115 on OFDM-capable STAs 115 by continuing to use a short slot time for transmit opportunities (TXOPs) by the OFDM-capable STAs 115. Even if an 802.11b-only STA 115 (which may use a long slot time) associates with the AP 105-b, the AP 105-b may not enable long slot operation throughout the WLAN. Rather AP 105-b may continue to utilize a short slot time for TXOPs of OFDM-capable STAs 115, while the 802.11b-only STAs 115 may use a short slot time. This imbalance of slot time length may cause the 802.11b-only STA 115 to have fewer TXOPs than an OFDM-capable STA 115. For example, the 802.11b-only STA 115 may have approximately half the TXOPs of an OFDM-capable STA 115 because long slots are 20 microseconds (us) in length and short slots are 9 us in length. The use of long slots by the 802.11b-only STA 115 may allow the 802.11b-only STA 115 to access the network with minimal effect to the OFDM-capable STAs 115. As such, the presence of an 802.11b-only device may not impact the performance of the Basic Service Set (BSS).

In certain examples, the range of the AP 105-b may be dynamically adjusted based on whether any STAs 115 are associated with the AP 105-b and, if so, what type of STAs 115 are associated with the AP 105-b. For example, when no STAs 115 are associated with the AP 105-b, the AP 105-b may refrain from transmitting beacons. In such cases, STAs may still discover the AP 105-b through active scanning (i.e., by transmitting a Probe Request message to the AP 105-b and receiving a Probe Response message from the AP 105-b). The AP 105-b may advertise support for 802.11b rates, including 1, 2, 5.5, and 11 Mbps.

When at least one STA 115 is associated with the AP 105-b, the AP 105-b may send beacons at a data rate that can be received by all associated STAs 115. This data rate may be referred to as the beacon rate, and may be selected based on the type of STAs 115 that are associated with the AP 105-b. For example, if only OFDM-capable STAs 115 are associated with the AP 105-b, the AP 105-b may transmit the beacons at an OFDM data rate. On the other hand, if an 802.11b-only STA 115 is associated with the AP 105-b, the AP 105-b may transmit the beacons at an 802.11b data rate.

The beacon rate may be determined based on the received signal strength indication (RSSI) of frames received from associated and associating STAs 115 such that the beacon will reach those STAs with excess signal-to-noise ratios (SNRs). Thus, if the STAs 115 move away from the AP, the STAs 115 will still be able to receive and decode the beacon at a lower SNR. The beacon rate may be dynamically adapted based on the latest knowledge at the AP about the received signal strengths from associated STAs 115 or receive SNRs at associated STAs 115. The signal strengths may be obtained by measurements on received frames from associated STAs 115. The receive SNRs may be obtained from periodic reports to the AP by the associated STAs 115.

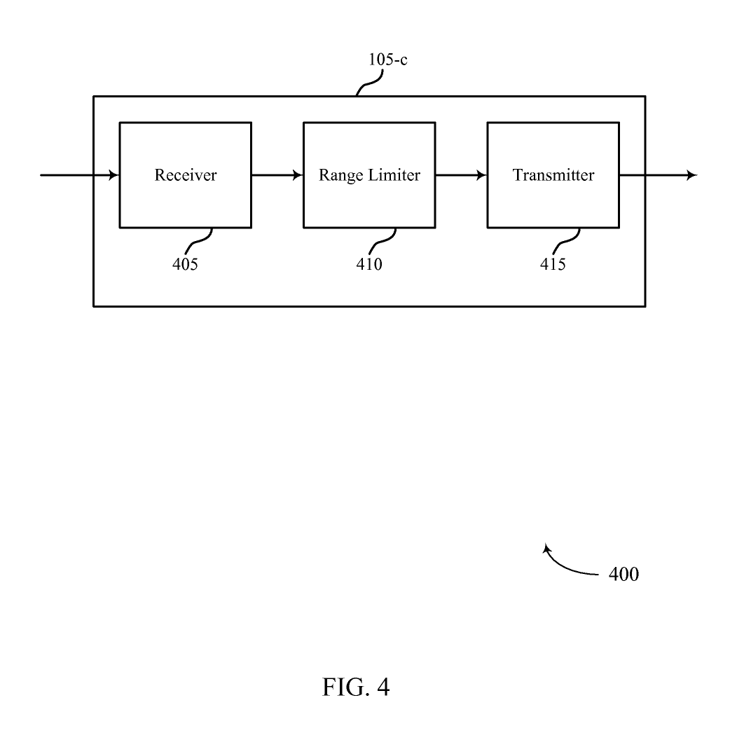

FIG. 4 shows a block diagram 400 of an AP 105-c for limiting the range of an AP in accordance with various embodiments. The AP 105-c may be an example of one or more aspects of an AP 105 described with reference to FIGS. 1-3. The AP 105-b may include a receiver 405, a range limiter 410, and/or a transmitter 415. The AP 105-c may also include a processor. Each of these components may be in communication with each other.

The components of the AP 105-c may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver 405 may receive information such as packets, user data, and/or control information associated with various information channels (e.g., control channels, data channels, etc.). Information may be passed on to the range limiter 410, and to other components of the AP 105-c. In some examples, the receiver 405 may be configured to receive a transmission from a wireless station at a first bit rate. For example, the receiver 405 may receive a transmission at a low bit rate that is advertised as a supported bit rate by the range limiter 410.

The range limiter 410 may be configured to advertise a plurality of supported bit rates, wherein the plurality of supported bit rates comprises a first subset of bit rates and a second subset of bit rates. The range limiter 410 may also be configured to receive a transmission from a wireless station at a first bit rate in coordination with the receiver 405. The range limiter 410 may be configured to adapt communication with the wireless station to limit a range of the AP 105-c based on a determination that the first bit rate is in the first subset. In some examples example, range limiter 410 may be configured to cause the AP 105-c to refrain from enabling legacy protection in response to receiving the transmission from the wireless station at the first bit rate.

In some examples example, range limiter 410 may be configured to continue implementing a short slot transmission opportunity (TXOP) after receiving the transmission from the wireless station at the first bit rate. In some examples example, range limiter 410 may be configured to refrain from transmitting beacons in response to a determination that no wireless stations are currently associated with the AP. In some examples example, range limiter 410 may be configured to identify one of the supported bit rates as a data rate that can be received by all wireless stations currently associated with the AP transmit a beacon at the identified one of the supported bit rates. In some examples example, one of the supported bit rates is identified based on a received signal strength indication (RSSI) for each of the wireless stations currently associated with the AP.

The transmitter 415 may transmit the one or more signals received from other components of the AP 105-c. For example, the transmitter 415 may transmit a message at a second bit rate of the second subset, wherein the message is selected from the group consisting of: a beacon and a probe response. As another example, the transmitter 415 may transmit beacon and group traffic at a second bit rate from the second subset of bit rates prior to receiving the transmission from the wireless station at the first bit rate. In some examples example, transmitter 415 may be configured to transmit group traffic at the identified one of the supported bit rates. In some embodiments, the transmitter 415 may be collocated with the receiver 405 in a transceiver. The transmitter 415 may include a single antenna or a plurality of antennas. In some examples, the transmitter 415 may be configured to transmit a beacon or a probe response at a second bit rate of the second subset.

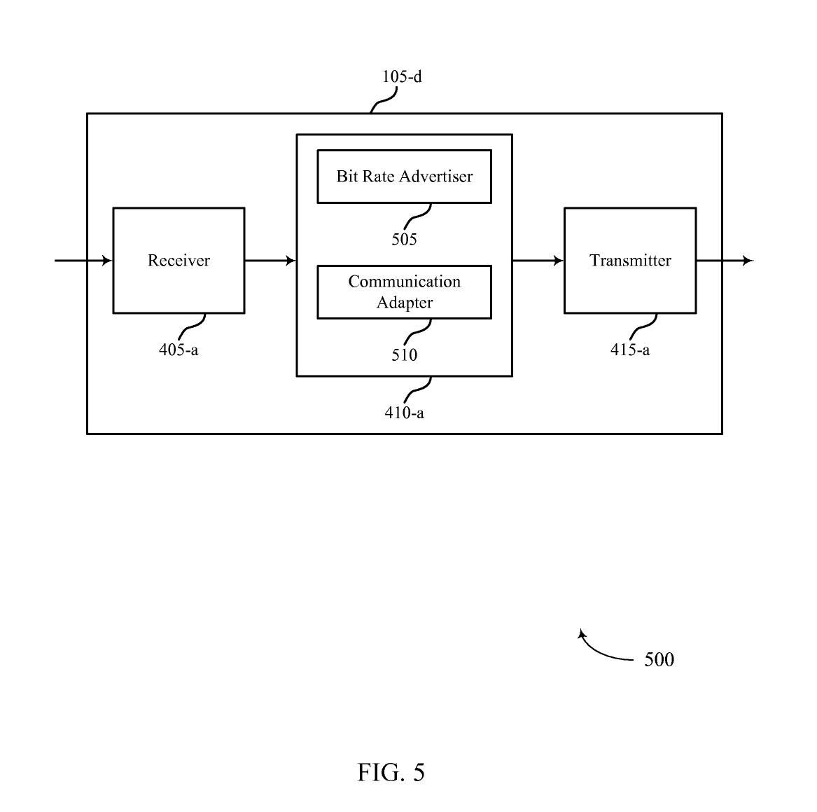

FIG. 5 shows a block diagram 500 of an AP 105-d for limiting the range of an AP in accordance with various embodiments. The AP 105-c may be an example of one or more aspects of an AP 105 described with reference to FIGS. 1-4. The AP 105-d may include a receiver 405-a, a range limiter 410-a, and/or a transmitter 415-a. The AP 105-d may also include a processor. Each of these components may be in communication with each other. The range limiter 410-a may also include a bit rate advertiser 505, and a communication adapter 510.

The components of the AP 105-d may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver 405-a may receive information which may be passed on to the range limiter 410-a, and to other components of the AP 105-d. The range limiter 410-a may be configured to perform the operations described above with reference to FIG. 4. The transmitter 415-a may transmit the one or more signals received from other components of the AP 105-d.

The bit rate advertiser 505 may be configured to advertise a plurality of supported bit rates, wherein the plurality of supported bit rates comprises a first subset of bit rates and a second subset of bit rates. In some examples advertising the plurality of supported bit rates comprises designating the bit rates of the first subset as basic rates. In some examples advertising the plurality of bit rates comprises transmitting an indication that the AP is refraining from using the bit rates of the first subset to communicate data packets. The bit rate advertiser may also coordinate with the transmitter 415-a to transmit beacons.

The communication adapter 510 may also be configured to restrict transmissions that use one of a set of bit rates (e.g., the first subset) and adapt communication with the wireless station to limit a range of the AP 105-d based on a determination that the bit rate is in the first subset. The communication adapter 510 may be configured such that the first subset of bit rates is associated with a longer transmission range than the second subset of bit rates. The communication adapter 510 may also be configured to cause the AP 105-d to refrain from using the bit rates of the first subset to communicate data packets. In one example, adapting communication with the wireless station comprises transmitting the beacon and group traffic at a bit rate selected from the first subset of bit rates in response to receiving the transmission from the wireless station at the first bit rate.

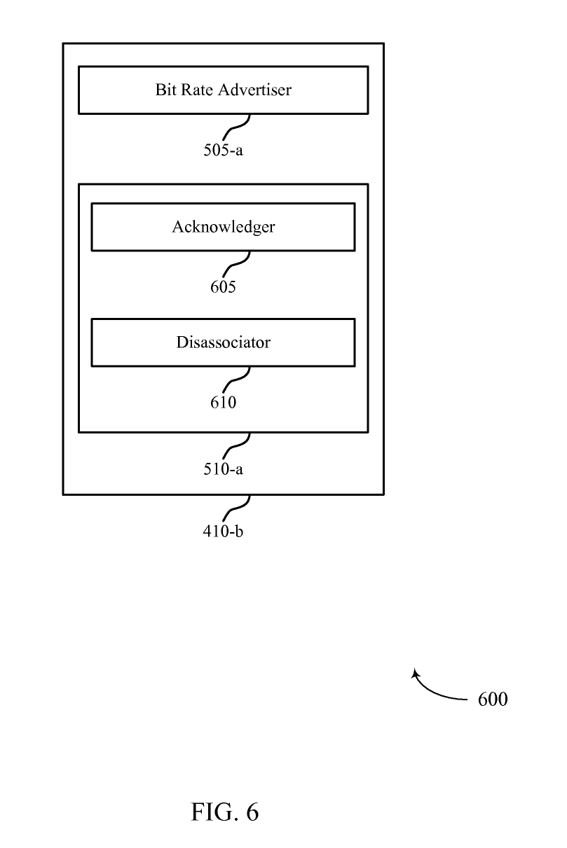

FIG. 6 shows a block diagram 600 of a range limiter 410-b for limiting the range of an AP in accordance with various embodiments. The range limiter 410-b may be an example of one or more aspects of a range limiter 410 described with reference to FIGS. 4-5. The range limiter 410-b may include a bit rate advertiser 505-a, and a communication adapter 510-a. Each of these components may perform the functions described above with reference to FIG. 5. The communication adapter 510-a may also include an Acknowledger 605, and a disassociator 610.

The components of the range limiter 410-b may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The Acknowledger 605 may be configured to restrict an AP 105 from transmitting an ACK to a wireless station 115. Refraining from transmitting the ACK may be a means of limiting the range of an AP 105 and/or optimizing usage of resources. Refraining from transmitting the ACK may result in a wireless station 115 disassociating from the AP 105.

The disassociator 610 may be configured to transmit a frame to a wireless station 115 in coordination with a transmitter. The frame may comprise a disassociation frame or a deauthentication frame. The disassociator 610 may be configured to cause the frame to be transmitted to the wireless station after an SIFS following the transmission from the wireless station 115. The disassociator 610 may be configured such that the frame is transmitted to the wireless station 115 at the first bit rate.

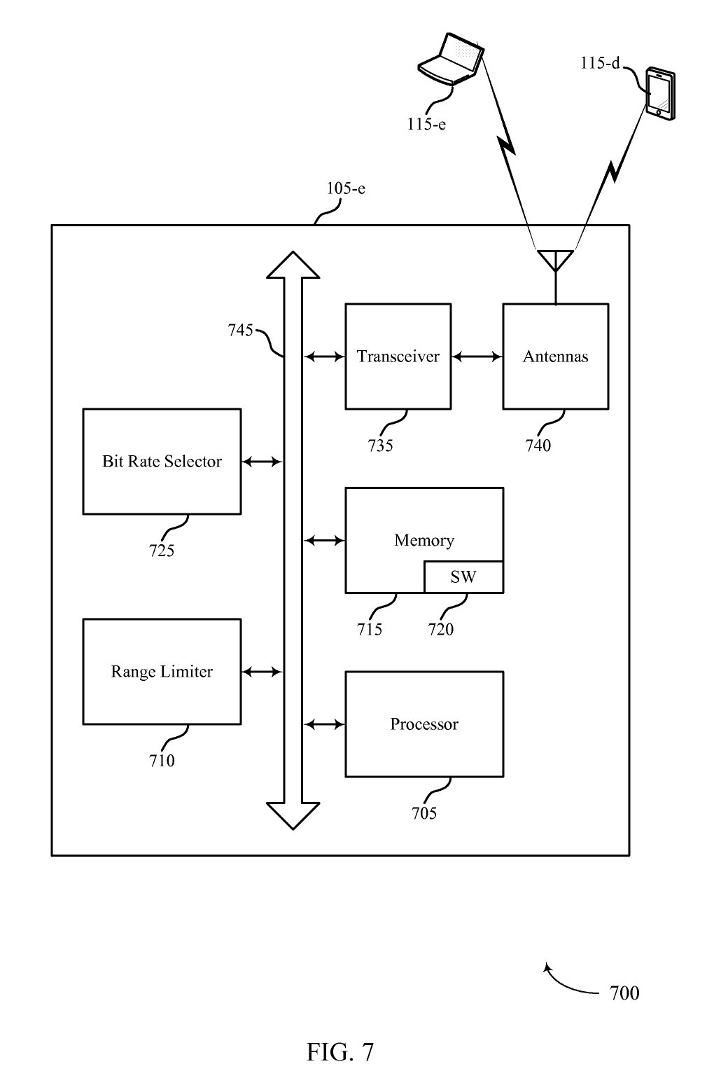

FIG. 7 shows a diagram of a system 700 for limiting the range of an AP 105-e in accordance with various embodiments. System 700 may include an AP 105-e, which may be an example of an AP 105 with reference to FIGS. 1-6. The AP 105-d may include a range limiter 710, which may be an example of a range limiter 410 with reference to FIGS. 4-6. The AP 105-d may also include a bit rate selector 725. The AP 105-e may also include components for bi-directional voice and data communications including components for transmitting communications and components for receiving communications.

The bit rate selector 725 may configure transmissions and/or received messages based on data rates that are supported by the AP 105-e. For example, the bit rate selector 725 may apply a modulation and coding scheme (MCS) to a message based on a selected bit rate. The bit rate selector 725 may also be configured to indicate a plurality of supported bit rates. For example, the bit rate selector 725 may designate the bit rates of a first subset as basic rates.

The AP 105-e may also include a processor 705, and memory 715 (including software (SW)) 720, a transceiver 735, and one or more antenna(s) 740, which each may communicate, directly or indirectly, with each other (e.g., via one or more buses 745. The transceiver 735 may be configured to communicate bi-directionally, via the antenna(s) 740 and/or one or more wired or wireless links, with one or more networks, as described above. For example, the transceiver 735 may be configured to communicate bi-directionally with another AP 105 (not shown) and/or with STAs 115 (e.g. STA 115-d and STA 115-e as shown). The transceiver 735 may include a modem configured to modulate the packets and provide the modulated packets to the antenna(s) 740 for transmission, and to demodulate packets received from the antenna(s) 740. While the AP 105-e may include a single antenna 740, the AP 105-e may also have multiple antennas 740 capable of concurrently transmitting and/or receiving multiple wireless transmissions.

The memory 715 may include random access memory (RAM) and read-only memory (ROM). The memory 715 may store computer-readable, computer-executable software/firmware code 720 containing instructions that are configured to, when executed, cause the processor 705 to perform various functions described herein (e.g., call processing, database management, processing of carrier mode indicators, reporting CSI, etc.). Alternatively, the software/firmware code 720 may not be directly executable by the processor 705 but be configured to cause a computer (e.g., when compiled and executed) to perform functions described herein. The processor 705 may include an intelligent hardware device, e.g., a central processing unit (CPU), a microcontroller, an application-specific integrated circuit (ASIC), etc. may include random access memory (RAM) and read-only memory (ROM). The memory 715 may store computer-readable, computer-executable software/firmware code 720 containing instructions that are configured to, when executed, cause the processor 705 to perform various functions described herein (e.g., call processing, database management, processing of carrier mode indicators, reporting CSI, etc.). Alternatively, the software/firmware code 720 may not be directly executable by the processor 705 but be configured to cause a computer (e.g., when compiled and executed) to perform functions described herein. The processor 705 may include an intelligent hardware device, e.g., a central processing unit (CPU), a microcontroller, an application-specific integrated circuit (ASIC), etc.

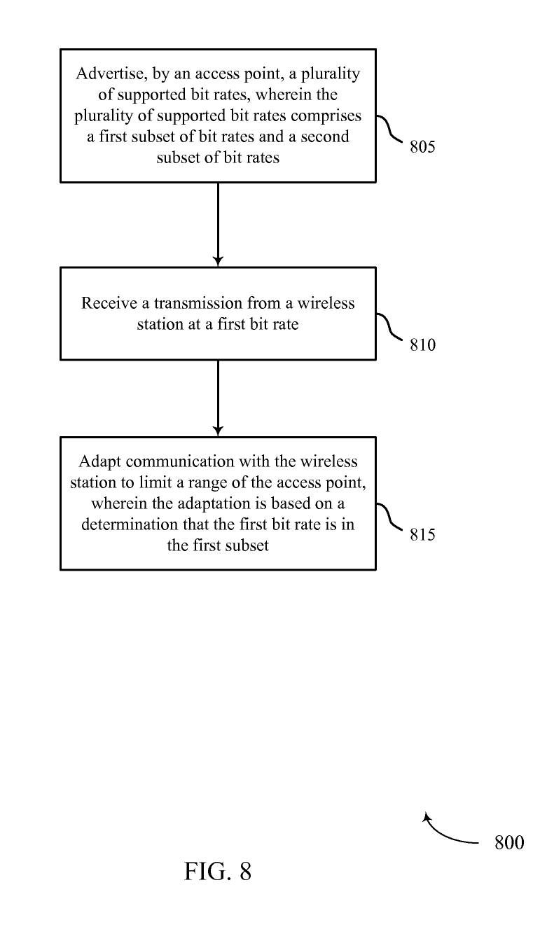

FIG. 8 shows a flowchart 800 illustrating a method for limiting the range of an AP in accordance with various embodiments. The functions of flowchart 800 may be implemented by an AP 105 or its components as described with reference to FIGS. 1-7. In certain examples, the blocks of the flowchart 800 may be performed by a range limiter with reference to FIGS. 4-7.

At block 805, an AP 105 may advertise a plurality of supported bit rates, wherein the plurality of supported bit rates comprises a first subset of bit rates and a second subset of bit rates. For example, the first subset of bit rates may include relatively low bit rates and the second subset of bit rates may include higher bit rates. The first and the second subsets may be disjoint subsets. In certain examples, the functions of block 805 may be performed by the bit rate advertiser 505 as described above with reference to FIG. 5.

At block 810, the AP 105 may receive a transmission from a wireless station 115 at a first bit rate. In certain examples, the functions of block 810 may be performed by the receiver 405 as described above with reference to FIG. 4.

At block 815, the AP 105 may adapt communication with the wireless station 115 to limit a range of the AP, wherein the adaptation is based on a determination that the first bit rate is in the first subset. In certain examples, the functions of block 815 may be performed by the communication adapter 510 as described above with reference to FIG. 5.

It should be noted that the method of flowchart 800 is just one implementation and that the operations of the method, and the steps may be rearranged or otherwise modified such that other implementations are possible.

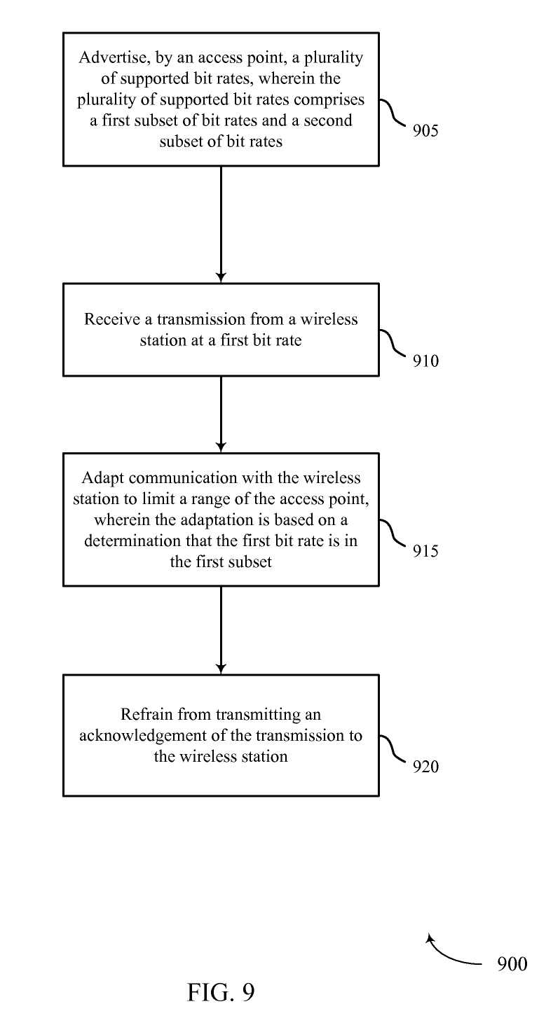

FIG. 9 shows a flowchart 900 illustrating a method for limiting the range of an AP in accordance with various embodiments. The functions of flowchart 900 may be implemented by an AP 105 or its components as described with reference to FIGS. 1-7. In certain examples, the blocks of the flowchart 900 may be performed by a range limiter with reference to FIGS. 4-7. The method described in flowchart 900 may also incorporate aspects of flowchart 800 of FIG. 8.

At block 905, an AP 105 may advertise a plurality of supported bit rates, wherein the plurality of supported bit rates comprises a first subset of bit rates and a second subset of bit rates. In certain examples, the functions of block 905 may be performed by the bit rate advertiser 505 as described above with reference to FIG. 5.

At block 910, the AP 105 may receive a transmission from a wireless station 115 at a first bit rate. In certain examples, the functions of block 910 may be performed by the receiver 405 as described above with reference to FIG. 4.

At block 915, the AP 105 may adapt communication with the wireless station 115 to limit a range of the AP, wherein the adaptation is based on a determination that the first bit rate is in the first subset. In certain examples, the functions of block 915 may be performed by the communication adapter 510 as described above with reference to FIG. 5.

At block 920, the AP 105 may refrain from transmitting an ACK of the transmission to the wireless station 115. This may be a part of the process of adapting communication with the wireless station 115 to limit the range of the AP 105. In certain examples, the functions of block 920 may be performed by the Acknowledger 605 as described above with reference to FIG. 6.

It should be noted that the method of flowchart 900 is just one implementation and that the operations of the method, and the steps may be rearranged or otherwise modified such that other implementations are possible.

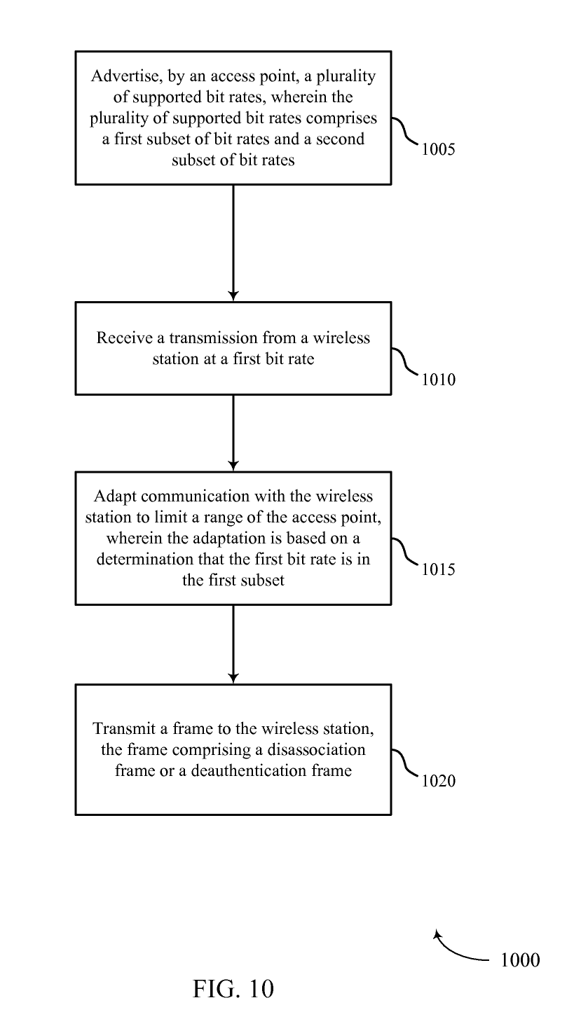

FIG. 10 shows a flowchart 1000 illustrating a method for limiting the range of an AP in accordance with various embodiments. The functions of flowchart 1000 may be implemented by an AP 105 or its components as described with reference to FIGS. 1-7. In certain examples, the blocks of the flowchart 1000 may be performed by a range limiter with reference to FIGS. 4-7. The method described in flowchart 1000 may also incorporate aspects of flowcharts 800 to 900 of FIGS. 8-9.

At block 1005, an AP 105 may advertise, by an AP, a plurality of supported bit rates, wherein the plurality of supported bit rates comprises a first subset of bit rates and a second subset of bit rates. In certain examples, the functions of block 1005 may be performed by the bit rate advertiser 505 as described above with reference to FIG. 5.

At block 1010, the AP 105 may receive a transmission from a wireless station 115 at a first bit rate. In certain examples, the functions of block 1010 may be performed by the receiver 405 as described above with reference to FIG. 4.

At block 1015, the AP 105 may adapt communication with the wireless station 115 to limit a range of the AP, wherein the adaptation is based on a determination that the first bit rate is in the first subset. In certain examples, the functions of block 1015 may be performed by the communication adapter 510 as described above with reference to FIG. 5.

At block 1020, the AP 105 may adapting communication with the wireless station comprises: transmitting a frame to the wireless station 115, the frame comprising a disassociation frame or a deauthentication frame. This may be a part of the process of adapting communication with the wireless station 115 to limit the range of the AP 105. In certain examples, the functions of block 1020 may be performed by the disassociator 610 as described above with reference to FIG. 6.

It should be noted that the method of flowchart 1000 is just one implementation and that the operations of the method, and the steps may be rearranged or otherwise modified such that other implementations are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of [at least one of A, B, or C] means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein, but is to be accorded the widest scope consistent with the principles and novel features disclosed herein.

What is claimed is:

1. A method of wireless communication, comprising:
advertising, by an access point (AP), a plurality of supported bit rates, wherein the plurality of supported bit rates comprises a first subset of bit rates and a second subset of bit rates;
receiving a transmission from a wireless station at a first bit rate; and
adapting communication with the wireless station to limit a range of the AP, wherein the adaptation is based at least in part on a determination that the first bit rate is in the first subset.

2. The method of claim 1, wherein the first subset of bit rates is associated with a longer transmission range than the second subset of bit rates.

3. The method of claim 1, wherein adapting communication with the wireless station comprises:
refraining from transmitting an acknowledgement of the transmission to the wireless station.

4. The method of claim 1, wherein adapting communication with the wireless station comprises:
transmitting a frame to the wireless station, wherein the frame is from the group consisting of a disassociation frame and a deauthentication frame.

5. The method of claim 1, wherein advertising the plurality of bit rates comprises:
transmitting an indication that the AP is refraining from using the bit rates of the first subset to communicate data packets.

6. The method of claim 1, further comprising:
refraining from using the bit rates of the first subset to communicate data packets.

7. The method of claim 1, further comprising:
transmitting beacon and group traffic at a second bit rate from the second subset of bit rates prior to receiving the transmission from the wireless station at the first bit rate,
wherein adapting communication with the wireless station comprises transmitting the beacon and group traffic at a bit rate selected from the first subset of bit rates in response to receiving the transmission from the wireless station at the first bit rate.

8. The method of claim 1, further comprising:
refraining from enabling legacy protection in response to receiving the transmission from the wireless station at the first bit rate.

9. The method of claim 1, further comprising:
identifying one of the supported bit rates as a data rate that can be received by all wireless stations currently associated with the AP, wherein the one of the supported bit rates is identified based at least in part on a received signal strength indication (RSSI) for each of the wireless stations currently associated with the AP;
transmitting a beacon at the identified one of the supported bit rates; and
transmitting group traffic at the identified one of the supported bit rates.

10. An apparatus for wireless communication, comprising:
means for advertising, by an access point (AP), a plurality of supported bit rates, wherein the plurality of supported bit rates comprises a first subset of bit rates and a second subset of bit rates;
means for receiving a transmission from a wireless station at a first bit rate; and
means for adapting communication with the wireless station to limit a range of the AP, wherein the adaptation is based at least in part on a determination that the first bit rate is in the first subset.

11. The apparatus of claim 10, wherein the first subset of bit rates is associated with a longer transmission range that the second subset of bit rates.

12. The apparatus of claim 10, further comprising:
means for refraining from using the bit rates of the first subset to communicate data packets.

13. The apparatus of claim 10, further comprising:
means for transmitting beacon and group traffic at a second bit rate from the second subset of bit rates prior to receiving the transmission from the wireless station at the first bit rate,
wherein the means for adapting communication with the wireless station comprises means for transmitting the beacon and group traffic at a bit rate selected from the first subset of bit rates in response to receiving the transmission from the wireless station at the first bit rate.

14. The apparatus of claim 10, further comprising:
means for refraining from enabling legacy protection in response to receiving the transmission from the wireless station at the first bit rate.

15. The apparatus of claim 10, further comprising:
means for identifying one of the supported bit rates as a data rate that can be received by all wireless stations currently associated with the AP, wherein the one of the supported bit rates is identified based at least in part on a received signal strength indication (RSSI) for each of the wireless stations currently associated with the AP;
means for transmitting a beacon at the identified one of the supported bit rates; and
means for transmitting group traffic at the identified one of the supported bit rates.

16. An apparatus for wireless communication, comprising:
a processor;
a bit rate advertiser to advertise a plurality of supported bit rates, wherein the plurality of supported bit rates comprises a first subset of bit rates and a second subset of bit rates;
a receiver to receive a transmission from a wireless station at a first bit rate; and
a communication adapter to adapt communication with the wireless station to limit a range of an access point (AP), wherein the adaptation is based at least in part on a determination that the first bit rate is in the first subset.

17. The apparatus of claim 16, further comprising:
a refrainer to refrain from using the bit rates of the first subset to communicate data packets.

18. The apparatus of claim 16, further comprising:
a transmitter to transmit beacon and group traffic at a second bit rate from the second subset of bit rates prior to receiving the transmission from the wireless station at the first bit rate,
wherein the communication adapter comprises a transmitter to transmit the beacon and group traffic at a bit rate selected from the first subset of bit rates in response to receiving the transmission from the wireless station at the first bit rate.

19. The apparatus of claim 16, further comprising:
a refrainer to refrain from enabling legacy protection in response to receiving the transmission from the wireless station at the first bit rate.

20. The apparatus of claim 16, further comprising:
an identifier to identify one of the supported bit rates as a data rate that can be received by all wireless stations currently associated with the AP, wherein the one of the supported bit rates is identified based at least in part on a received signal strength indication (RSSI) for each of the wireless stations currently associated with the AP;
a transmitter to transmit a beacon at the identified one of the supported bit rates; and
the transmitter to transmit group traffic at the identified one of the supported bit rates.
